(19) United States
(12) Patent Application Publication
(10) Pub. No.: US 2010/0039622 A1
(43) Pub. Date: Feb. 18, 2010

(54) PROJECTION DEVICE

(75) Inventor: CHUN-HSUN WANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/340,750

(22) Filed: Dec. 22, 2008

(30) Foreign Application Priority Data
Aug. 14, 2008 (CN) 200810303767.6

(51) Int. Cl. G03B 21/14

(52) U.S. Cl. 353/31

(57) ABSTRACT

A projection device, having a number of light emitting diodes and an integration rod, includes a rotatable wheel. The rotatable wheel is averagely divided into different color sectors. The same color light emitting diodes are populated in the corresponding color sectors and emit the corresponding color light. The rotatable wheel and the integration rod are positioned in the path of the color light.

### BACKGROUND

1. Technical Field

The disclosure relates to projection devices and, particularly, to a projection device using light emitting diodes (LEDs) as a light source.

2. Description of the Related Art

Projectors using LEDs as a light source typically include three groups of color LEDs and a dichroic device such as a dichroic mirror for combining light therefrom into white light. In such a projector, efficiency of the light source mostly depends upon assembly precision thereof. For example, if the LEDs are misaligned with the dichroic device, efficiency suffers. Unfortunately, in practice, such misalignment is unavoidable. Furthermore, such a light source is not compatible with compactness requirement for a projector due to the presence of the bulky dichroic device. Moreover, heat dissipation is also a major concern.

Therefore, it is desirable to provide a projection device which can overcome the limitations described above.

### BRIEF DESCRIPTION OF THE DRAWINGS

FIG. 1 is an isometric, schematic view of a projection device, according to an exemplary embodiment.

FIG. 2 is a planar, partial, schematic view of the projection device of FIG. 1.

FIG. 3 is a functional block diagram of the projection device of FIG. 1.

### DETAILED DESCRIPTION OF THE EMBODIMENTS

Embodiments of the projection device are described in detail here with reference to the drawings.

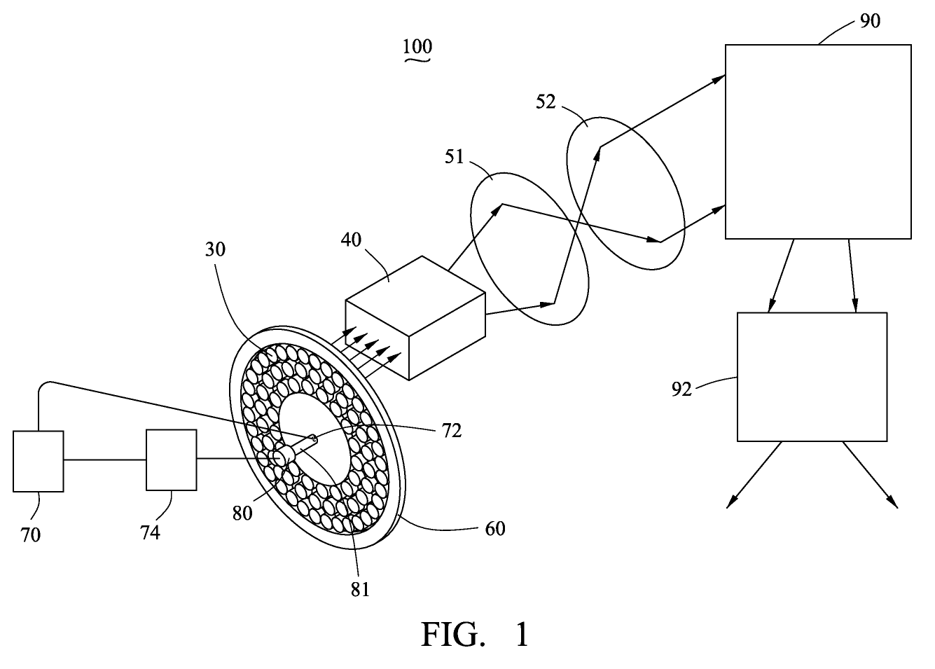

As shown in FIG. 1, a projection device 100, according to an exemplary embodiment, includes a number of color LEDs 30, an integration rod 40, a first focus lens 51, a second focus lens 52, a rotatable wheel 60, a processing unit 70, a LED driving unit 72, a motor 80, a motor driving unit 74, a spatial light modulator 90, and a projection lens 92. The processing unit 70 coordinates components of the projection device 100 to execute projection function. The LED driving unit 72 positioned on the rotatable wheel 60 is electrically coupled to and controls the motor driving unit 74 to rotate the rotatable wheel 60.

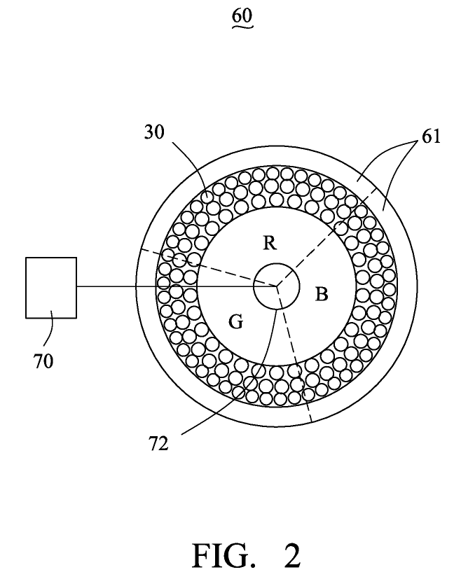

Referring to FIG. 2, the rotatable wheel 60 is equally divided into three sectors 61: red (R), green (G), and blue (B). The color LEDs 30 include a group of red LEDs, a group of green LEDs, and a group of blue LEDs. Each group of the color LEDs 30 is located in a corresponding sector. In an example, the group of red LEDs is arranged in the R sector, the group of green LEDs is arranged in the G sector, and the group of blue LEDs is arranged in the B sector.

The integration rod 40 is aligned with one of the three sectors 61 of the rotatable wheel 60. Thereby, when the rotatable wheel 60 is rotated by the motor 80, color light emitted from the three sectors 61 will be directed to the integration rod 40 in sequence. For example, as shown in FIG. 2, if the rotatable wheel 60 rotates clockwise, sequential color lights: R-G-B will be produced and transmitted through the integration rod 40 to the first focus lens 51.

The first and second focus lenses 51, 52 are also arranged in the path of the emitted light from the near end to the far end of the integration rod 40. The first and second lenses 51, 52 are configured for collecting the sequential color lights to produce an illumination onto the spatial light modulator 90.

The spatial light modulator 90, such as a digital micro-mirror device (DMD), modulates illumination incident thereon into optical images based upon video information input thereto.

The projection lens 92 projects the optical images onto a screen (not shown).

The motor 80 includes a driving rod 81 perpendicularly connected to the central portion of the rotatable wheel 60, and electrically couples to the motor driving unit 74.

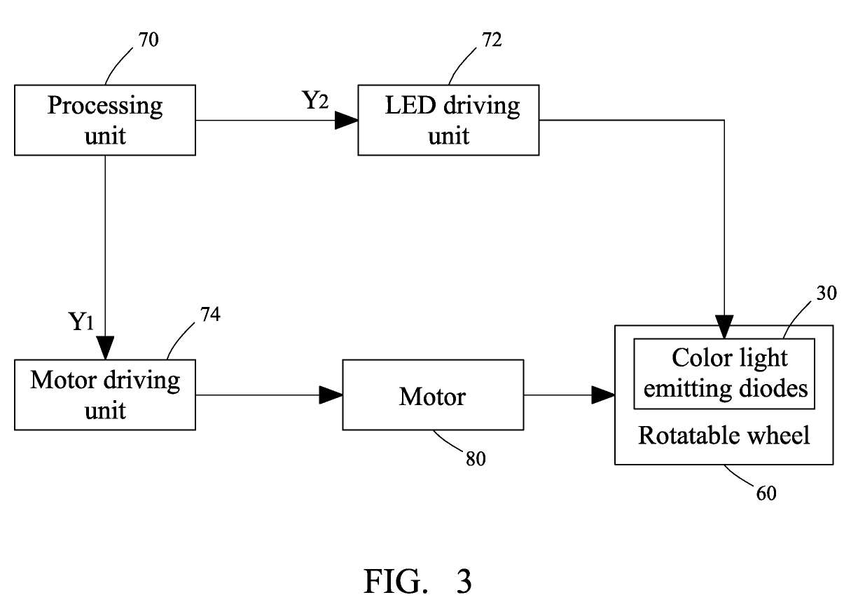

Also referring to FIG. 3, the processing unit 70 produces motor operation timing signals Y1 and LED operation timing signals Y2. The motor operation timing signals Y1 drive the motor 80 to rotate the rotatable wheel 60 at a predetermined speed. The LED operation timing signals Y2 power the color LEDs 30 on and off, synchronized with the rotation of the rotatable wheel 60, so that a sector 61 of color LEDs 30 is powered on only when that sector is aligned with the integration rod 40.

The projection device 100 includes different color LEDs 30 fixed to the corresponding color sectors 60 of the rotatable wheel 61 and the integration rod 40 in the path of the emitted light from the rotatable wheel 61. It is noted that the projection device 100 requires no dichroic elements, thereby enhancing illumination efficiency and aiding minimization of the dimensions of the projection device 100. Moreover, rotation of the rotatable wheel 60 increases airflow, thus enhancing heat dissipation.

While the disclosure has been described by way of example and in terms of preferred embodiment, it is to be understood that the disclosure is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A projection device, comprising a plurality of color light emitting diodes and an integration rod, a rotatable wheel equally divided into different color sectors, with the plurality of color light emitting diodes of a single color being arranged in a corresponding color sector and emitting corresponding color light, wherein the rotatable wheel and the integration rod are in the path of the color light.

2. The projection device of claim 1, wherein the integration rod is aligned with one of the sectors of the rotatable wheel.

3. The projection device of claim 1, further comprising a motor comprising a driving rod perpendicularly connected to the rotatable wheel, and electrically coupled to a motor driving unit configured for activating rotation of the motor.

4. The projection device of claim 3, further comprising a light emitting diode driving unit electrically coupled to the motor driving unit and configured to control the motor driving unit to rotate the rotatable wheel to rotate.

5. The projection device of claim 1, further comprising a spatial light modulator configured for modulating the illumination incident thereon into optical images based up on optical information input thereto.

6. The projection device of claim 5, wherein the spatial light modulator is a digital micro-mirror device.

7. The projection device of claim 5, further comprising a first focus lens and a second focus lens arranged in the path of the emitted light and configured for collecting the sequential color lights to produce an illumination onto the spatial light modulator.

8. The projection device of claim 4, further comprising a processing unit configured for coordinating components of the projection device to perform the projection function and producing a motor operation timing signals and a light emitting diode operation timing signals.

9. The projection device of claim 8, wherein the motor operation timing signals are configured for activating the motor to rotate the rotatable wheel at a predetermined speed.

10. The projection device of claim 8, wherein the light emitting diode operation timing signals are configured for powering the color light emitting diodes, synchronized with the rotation of the rotatable wheel.

11. A projection device, comprising:
a plurality of color light emitting diodes; a rotatable wheel averagely divided into different color sectors, the same color light emitting diodes being populated in the corresponding color sectors and emitting the corresponding color light; and an integration rod aligned with one of the color sectors of the rotatable wheel, the rotatable wheel and the integration rod being positioned in the path of the color light.

12. The projection device of claim 11, further comprising a motor comprising a driving rod perpendicularly connected to the rotatable wheel, and being electrically coupled to a motor driving unit configured for activating rotation of the motor.

13. The projection device of claim 12, further a light emitting diode driving unit being electrically coupled to the motor driving unit and configured to control the motor driving unit to rotate the rotatable wheel to rotate.

14. The projection device of claim 11, further comprising a processing unit capable of generating a motor operation timing configured for activating the motor to let the driving rod rotate the rotatable wheel.

15. The projection device of claim 11, further comprising a light emitting diode driving unit positioned on the rotatable wheel.

16. The projection device of claim 11, further comprising a spatial light modulator configured for modulating the illumination incident thereon into optical images based up on optical information input thereto and the spatial light modulator is a digital micro-mirror device.

17. The projection device of claim 15, further comprising a first focus lens and a second focus lens arranged in the path of the emitted light and configured for collecting the sequential color lights to produce an illumination onto the spatial light modulator.

18. The projection device of claim 12, further comprising a processing unit configured for coordinating components of the projection device to perform the projection function and producing a motor operation timing signals and a light emitting diode operation timing signals.

19. The projection device of claim 18, wherein the motor operation timing signals are configured for activating the motor to rotate the rotatable wheel at a predetermined speed.

20. The projection device of claim 18, wherein the light emitting diode operation timing signals are configured for powering the color light emitting diodes, synchronized with the rotation of the rotatable wheel.
